(19) United States
(12) Patent Application Publication
(10) Pub. No.: US 2018/0007233 A1
(43) Pub. Date: Jan. 4, 2018

(54) IMAGE FORMING DEVICE AND SEMICONDUCTOR DEVICE

(71) Applicant: Renesas Electronics Corporation, Tokyo (JP)

(72) Inventors: Hirotaka ARAMAKI, Tokyo (JP); Naonobu WASAKI, Tokyo (JP)

(73) Assignee: Renesas Electronics Corporation, Tokyo (JP)

(21) Appl. No.: 15/631,268

(22) Filed: Jun. 23, 2017

(30) Foreign Application Priority Data
Jul. 1, 2016 (JP) 2016-131283

(51) Int. Cl. H04N 1/44; G06K 9/00; H04N 1/00

(52) U.S. Cl. CPC H04N 1/442; H04N 1/00442; H04N 1/00469; G06K 9/00456; H04N 1/00336; H04N 1/00251; H04N 2201/0094

(57) ABSTRACT

In an image forming device including a document platen, a scanning mechanism, and a controller, a preview screen is small and difficult to see, and it is not possible to adjust position and size on the preview screen after scanning.

The document platen has a document platen display unit controlled by the controller. The scanning mechanism can read an image of a document placed on the document platen and transmit read initial image data to the controller. The controller can cause the document platen display unit to display image data based on the initial image data. The controller realized as an LSI includes a device interface for controlling the scanning mechanism and receiving the read initial image data from the scanning mechanism and a document platen display unit interface for causing the document platen display unit to display image data based on the initial image data.

### CROSS-REFERENCE TO RELATED APPLICATIONS

The disclosure of Japanese Patent Application No. 2016-131283 filed on Jul. 1, 2016 including the specification, drawings and abstract is incorporated herein by reference in its entirety.

### BACKGROUND

The present invention relates to an image forming device and a semiconductor device and, in particular, the present invention can be preferably used for an image forming device having an image forming function such as printing a scanned image and a semiconductor device for controlling the image forming device.

For an image forming device represented by a multifunction machine having functions of copier, scanner, and printer, various contrivances have been proposed in order to increase functionality and improve user operability.

Japanese Unexamined Patent Application Publication No. 2009-100102 discloses an image forming device whose operability is improved by simplifying items that should be set by a user by specifying a type of a document to be scanned. FIG. 1 in the above patent document shows a system block diagram of the image forming device. When forming and printing one image from a specific plurality of document surfaces such as driver's licenses, it is possible to form an image at a suitable position by a simple operation. Specifically, it s possible to display a screen to specify a vertical arrangement or a horizontal arrangement of the documents as shown in FIG. 3 of the patent document and a preview screen as shown in FIG. 10 of the patent document.

Japanese Unexamined Patent Application Publication No. 2004-191447 discloses an image reading device that does not require a document platen cover, does not require opening/closing operations, prevents external light from entering the inside of the device from outside, and prevents a scanning light beam emitted from the inside of the device from leaking to the outside. A liquid crystal layer is provided to a document platen, and a shielding state and a transmission state are controlled for each small region.

### SUMMARY

The inventors of the present invention have studied Japanese Unexamined Patent Application Publications No. 2009-100102 and No. 2004-191447. As a result, the inventors have found that there are new problems as described below.

Japanese Unexamined Patent Application Publication No. 2009-100102 describes that it is possible to form an image by a simple operation when forming/copying one image from a specific plurality of document surfaces such as driver's licenses by the image forming device disclosed in the patent document. However, there are problems that the preview screen is small and difficult to see and it is not possible to adjust position and size on the preview screen after scanning.

A problem that the document is easily moved by, for example, a wind pressure generated when the document, platen cover is being closed, which is indicated in Japanese Unexamined Patent Application Publication No. 2004-191447, is expected to be solved by applying the invention disclosed in the patent document to the invention disclosed in Japanese Unexamined Patent Application Publication No. 2009-100102. However, it is still not possible to solve the problems that the preview screen is small and difficult to see and it is not possible to adjust position and size on the preview screen after scanning.

While means for solving these problems will be described below, the other problems and novel features will become apparent from the description of the present specification and the accompanying drawings.

According to an embodiment, the means for solving these problems are as follows.

An image forming device including a document platen, a scanning mechanism, and a controller is configured as described below. The document platen has a document platen display unit that is controlled by the controller. The scanning mechanism can read an image of a document placed on the document platen and transmit read initial image data to the controller. The controller can cause the document platen display unit to display image data based on the initial image data.

The controller can be configured as a semiconductor device. The semiconductor device includes a device interface for controlling the scanning mechanism and receiving the read initial image data from the scanning mechanism and a document platen display unit interface for causing the document platen display unit to display image data based on the initial image data.

The following explains briefly the effect obtained by the embodiment.

It is possible to cause the document platen display unit, which can have the same area as that of the document platen, to display image data read by the scanner, so that it is possible to display a preview image at an arbitrary size including an actual size.

### BRIEF DESCRIPTION OF THE DRAWINGS

FIG. 1 is a block diagram showing a configuration example of an image forming device and a semiconductor device according to a first embodiment.

FIG. 2 is a perspective view of an upper portion of a copying machine that is an example of the image forming device according to the first embodiment.

FIG. 3 is a display example of a guide screen for reading a front surface of a document, which is displayed on a document platen display unit.

FIG. 4 is a display example of a preview screen that displays the front surface of the document and a guide screen for reading a back surface of the document, which are displayed on the document platen display unit.

FIG. 5 is a display example of a preview screen that displays the front surface and the back surface of the document, which is displayed on the document platen display unit.

FIG. 6 is a display example of a preview screen where size and position of the front surface and the back surface have been adjusted, which is displayed on the document platen display unit.

FIG. 7 is an image diagram where images in FIG. 6 are printed.

FIG. 8 is a flowchart showing an operation example of the image forming device according to the first embodiment.

FIG. 9 is a flowchart showing an operation example of an image forming device according to a second embodiment.

### DETAILED DESCRIPTION

Embodiments will be described in detail. In all the drawings for explaining the embodiments for carrying out the invention, components having the same functions are denoted by the same reference numerals and repetitive description thereof will be omitted.

### First Embodiment

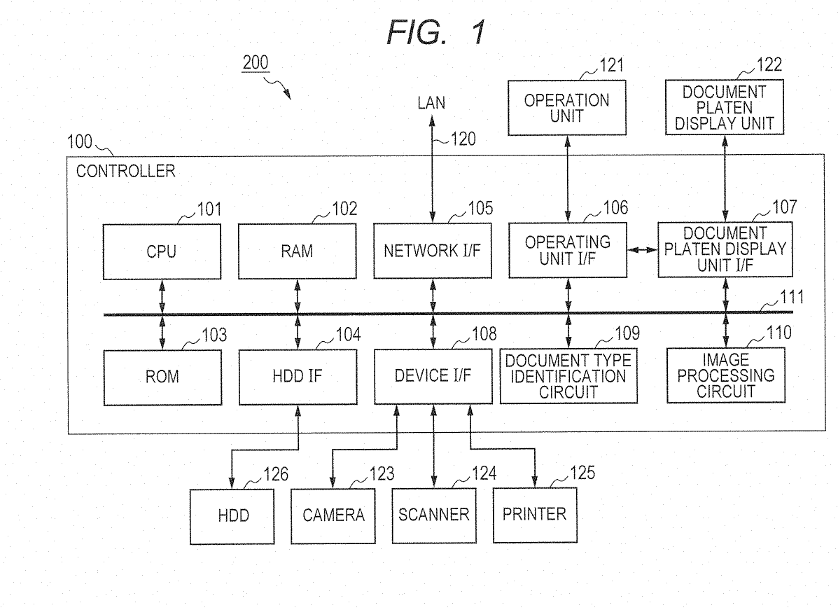

FIG. 1 is a block diagram showing a configuration example of an image forming device 200 according to a first embodiment. An arbitrary number of signal lines are installed in each wiring in FIG. 1. However, in FIG. 1, the numbers of signal lines are not shown and a so-called vector notation is omitted.

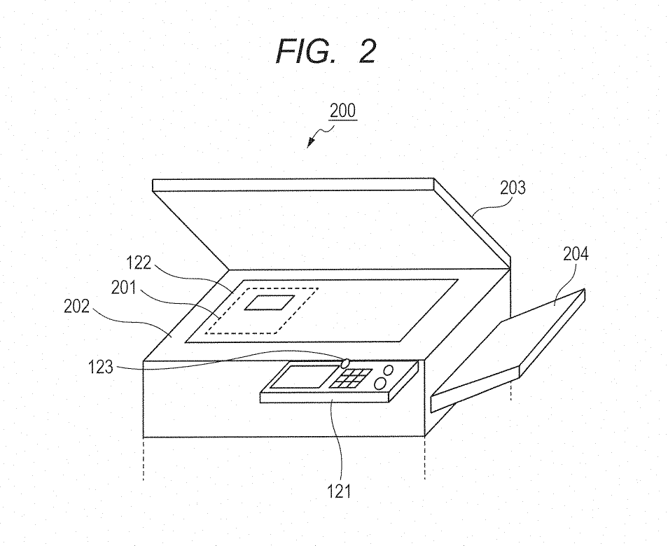

The image forming device 200 is, for example, a copying machine. FIG. 2 is a perspective view of an upper portion of the image forming device 200. The image forming device 200 includes a main body 202, an operation unit 121, a document platen 201, a document platen cover 203, and a paper discharge tray 204. The copying machine 200 can further include a camera 123 that can capture an image of a user in, for example, the operation unit 121. A function of the camera 123 be described in a second embodiment.

For example, in the same manner as Japanese Unexamined Patent Application Publication No. 2004-191447, a document platen display unit 122 can be formed by arranging liquid crystal cells under a transparent plate (for example, a glass plate) that forms the document platen 201. When a scanner 124 is being operated, a transmittance of some liquid crystal cells is controlled to be maximum (transparent) and an area to be scanned is formed. In an area not to be scanned, the transmittance is controlled to be minimum and light can be shielded. In the first embodiment (the same goes for the second embodiment), the liquid crystal cells are formed as a transmission type liquid crystal display panel by employing, for example, active matrix type liquid crystal cells and performing gradation display by controlling transmittance (polarization) for each liquid crystal cell.

The image forming device 200 includes the document platen 201, the scanner 124 that is a scanning mechanism, and a controller 100. The document platen 201 has the document platen display unit 122 that is controlled by the controller 100. The scanner 124 reads an image of a document placed on the document platen 201 and transmits read initial image data to the controller 100. The controller 100 is configured to be able to cause the document platen display unit 122 to display image data based on the initial image data read by the scanner 124.

The controller 100 is, for example, a semiconductor device realized as an LSI (Large Scale Integrated circuit) of SoC (System On a Chip). The controller 100 includes a device interface 108 for controlling the scanner 124 to receive the initial image data read from the scanner 124 and a document platen display unit interface 107 for causing the document platen display unit 122 to display the image data based on the initial image data.

Thereby, it is possible to cause the document platen display unit 122 that can have the same area as that of the document platen 201 to display the image data read by the scanner 124, so that it is possible to display a preview image at an arbitrary size including an actual size.

The image forming device 200 includes a printer 125 that is a printing mechanism of the copying machine in FIG. 2. The controller 100 can edit the initial image data read by the scanner 124 and cause the document platen display unit 122 to display either one or both of the initial image data before being edited and image data after being edited. Further, the controller 100 can form print data including either one or both of the initial image data before being edited and the image data after being, edited and cause the printer 125 to print the print data.

The controller 100 includes an image processing circuit 110 to realize the above function. The image processing circuit 110 can edit the initial image data to form the image data after being edited and form either one or both of preview image data and print data. Each of the preview image data and the print data includes either one or both of the initial image data and the image data after being edited. The document platen display unit interface 107 performs control to output the preview image data to the document platen display unit 122 and cause the document platen display unit 122 to display the preview image data. The device interface 108 performs control to output the print data to the printer 125 and cause the printer 125 to print the print data.

Thereby, it is possible to perform preview display of the image data read by the scanner 124 on the document platen display unit 122 by the controller 100 and further perform editing to adjust the position and size of the image by using the controller 100.

It is preferable that the controller 100 further includes a document type identification circuit 109 that can identify the type of the document based on the initial image data read by the scanner 124. The document platen display unit interface 107 performs control to cause the document platen display unit 122 to display a guide screen that snows a reading guide area where the document should be placed according to a result of identification by the document type identification circuit 109.

Thereby, it is possible to guide a user to set a document to an appropriate position when reading the document by the scanner 124.

At this time, the document platen display unit interface 107 can display the initial image data in the reading guide area of the document platen display unit 122.

Thereby, it is possible to perform preview display of the image data of the document read by the scanner 124 in the reading guide area at an actual size.

The document platen display unit interface 107 makes the reading guide area of the document platen display unit 122 transparent and blocks transmission of light in the other area.

Thereby, when the scanner 124 reads the document in the reading guide area, the area other than the reading guide area is shielded by the document platen display unit 122, so that it is possible to suppress leakage of light during scanning.

Configuration and operation of the image forming device 200 according the first embodiment and the controller 100 configured as an LSI chip will be described in further detail.

FIG. 1 shows a configuration example of the image forming device 200 and the controller 100. The image forming device 200 includes the controller 100, the operation unit 121, the document platen display unit 122, the camera 123, the scanner 124, the printer 125, and an HDD (Hard Disk Drive) 126.

When the image forming device 200 is a copying machine as shown in FIG. 2, the operation unit 121 is a console which a user operates, and the operation unit 121 includes, for example, a small liquid crystal display touch panel. Operations such as menu display, preview display, help display, error display, copy instruction, scan instruction, and various settings can be performed from the operation unit 121. While it is further preferable that the operation unit 121 includes the camera 123 that captures an image of a user who operates the operation unit 121, such an embodiment will be described in detail in the second embodiment.

For example, as described above, the document platen display unit 122 is a transmission type liquid crystal display panel configured by arranging liquid crystal cells under a transparent plate (for example, a glass plate) that forms the document platen 201. The document platen display unit 122 can display images and characters. The document platen display unit 122 has the same size as that of the document platen 201 or may be formed in a partial area of the document platen 201. The scanner 124 and the printer 125 are an image input device and an image output device included in the image forming device 200 as a copying machine. The HDD 126 stores software supplied to the controller 100 and data such as image information of image read by the scanner 124. The controller 100 can couple to LAN 120.

Although not particularly limited, the controller 100 is realized as an LSI of System on a Chip (SoC) and is formed on a single substrate such as silicon by using, for example, a known manufacturing technique of CMOS (Complementary Metal-Oxide-Semiconductor field effect transistor) semiconductor. The controller 100 includes a CPU (Central Processing Unit) 101, a RAM (Random. Access Memory) 102, a ROM (Read Only Memory) 103, an HDD interface 104, and a network interface 105. The controller 100 further includes an operation unit interface 106, the document platen display unit interface 107, the device interface 108, the document type identification circuit 109, and the image processing circuit 110. In the controller 100, the above units are coupled to a system bus 111. A storage including the RAM 102, the ROM 103, and an externally coupled HOD 126 may be hierarchized, and accordingly or irrelevantly to the hierarchization of the storage, the system bus 111 may be hierarchized.

The CPU 101 is a central control unit that controls the entire system. The RAM 102 is a system work memory used for operation of the CPU 101 and is also an image memory for executing system software that controls the controller 100 and temporarily storing image data. The ROM 103 is a boot ROM and a boot program of the system is stored in the ROM 103. The HDD 126 externally coupled through the HDD interface 104 is a hard disk drive and stores system software and image data.

The operation unit interface 106 is an interface unit with the operation unit 121 and outputs image data to be displayed on the operation unit 121 to the operation unit 121. Further, the operation unit interface 106 transmits information inputted from the operation unit 121 by a user of the system to the CPU 101. The operation unit 121 is an operation unit including a display touch panel and is provided with a start key that indicates start of processing and hard keys for inputting a telephone number and a numeric value in addition to the display touch panel. The user inputs various information for operating the image forming device 200 through the operation unit 121.

The document platen display unit interface 107 is an interface unit with the document platen display unit 122 and outputs image data to be displayed on the document platen display unit 122 to the document platen display unit 122. Further, the document platen display unit interface 107 transmits information inputted from the document platen display unit 122 by the user of the system to the CPU 101. The document platen display unit 122 uses a transmission type liquid crystal panel having a touch panel, and a touch panel operation can be performed on the document platen display unit 122. A technique where a liquid crystal panel is used for the document platen display unit 122 is realized by, for example, content of Japanese Unexamined Patent Application Publication No. 2004-191447. The document platen display unit 122 can display a preview screen of copy at actual size. The user can adjust size, position, and the like of a document image by a display touch panel operation on the preview screen through the document platen display unit 122. An image displayed by the document platen display unit 122 and an image displayed by the operation unit 121 may be synchronized with each other in real time so that a wheelchair user or the like who cannot see well the screen of the document platen display unit 122 can perform screen operations on the operation unit 121.

The network interface 105 is coupled to the LAN 120 and performs input/output of information. Although LAN is described us an example of a network, the network may be a wireless network such as WiFi.

The device interface 108 couples the controller 100 with the camera 123, the scanner 124, and the printer 125 and performs timing conversion of synchronization/a synchronization of image data. The image processing circuit 110 performs correction, processing, and the like on scanner input image data and performs printer correction, resolution conversion, and the like on print output image data. The document type identification circuit 109 performs image recognition using feature extraction and the like on image data of a document read from the scanner 124 and identifies a document type such as a driver's license and a passport.

All or part of the image processing circuit 110 and the document type identification circuit 109 may be realized as a function of a program running on the CPU 101 instead of hardware as illustrated in FIG. 1.

The operation of the controller 100 will be described.

When the power of the controller 100 is turned on, the CPU 101 loads the boot program stored in the ROM 103 into the RAM 102 and performs start-up sequence. The CPU 101 causes the image forming device 200 to be in a usable state by loading the system software from the HDD 126 into the RAM 102 and executing the system software. The executed system software reads screen configuration information stored in the HDD 126 and constructs an operation screen on the display touch panel of the operation unit 121 through the operation unit interface 106. When a user operates the operation unit 121 and instructs copying, the system software controls the scanner 124 and the printer 125 through the device interface 108 and performs copy processing of a document. An image read from the scanner 124 is transmitted to the image processing circuit 110 through the system bus 111. The image processing circuit 110 performs a copy operation by performing predetermined image processing on the image, transmitting the image to the printer 125 through the system bus 111, and transferring the image onto a predetermined paper sheet. When the user instructs scanning by operating the operation unit 121, the system software controls the scanner 124 through the device interface 108 and performs read processing of a document. An image read from the scanner 124 is transmitted to the image processing circuit 110 through the system bus 111. The image processing circuit 110 performs predetermined image processing, transmits data to the RAM 102 through the system bus 111, and stores image data in a predetermined image storage place of the HDD 126. Subsequently, the system software controls the printer 125 through the device interface 108 and performs a print operation. The image data stored in the RAM 102 and the HDD 126 are transmitted to the image processing circuit 110 through the system bus 111. After predetermined image processing is performed in the image processing circuit 110, data after the image processing is transmitted to the printer 125 through the device interface 108.

When a copy instruction and a scan instruction are issued by using the document platen display unit 122 instead of the operation unit 121, the same operation is performed.

The entire configuration of the image forming device 200 when the image forming device 200 is a copying machine as shown in FIG. 2 will be described.

FIG. 2 is a perspective view of an upper portion of the copying machine. The copying machine 200 has the operation unit 121, the document platen 201, the document platen display unit 122, the copying machine main body 202, the document platen cover 203, and the paper discharge tray 204. While a glass plate is normally used for the document platen 201, the document platen display unit 122 having a transmission type liquid crystal including a touch panel is laminated on the glass plate or the glass plate is replaced with the document platen display unit 122. The user places a document such as a driver's license or the like on the document platen 201 having the document platen display unit 122 and scans or copies the document. At this time, the user can cause the document platen display unit 122 to display a guide screen for scanning or copying the driver license or the like.

The operation of the image forming device 200 and the controller 100 wall be described in further detail.

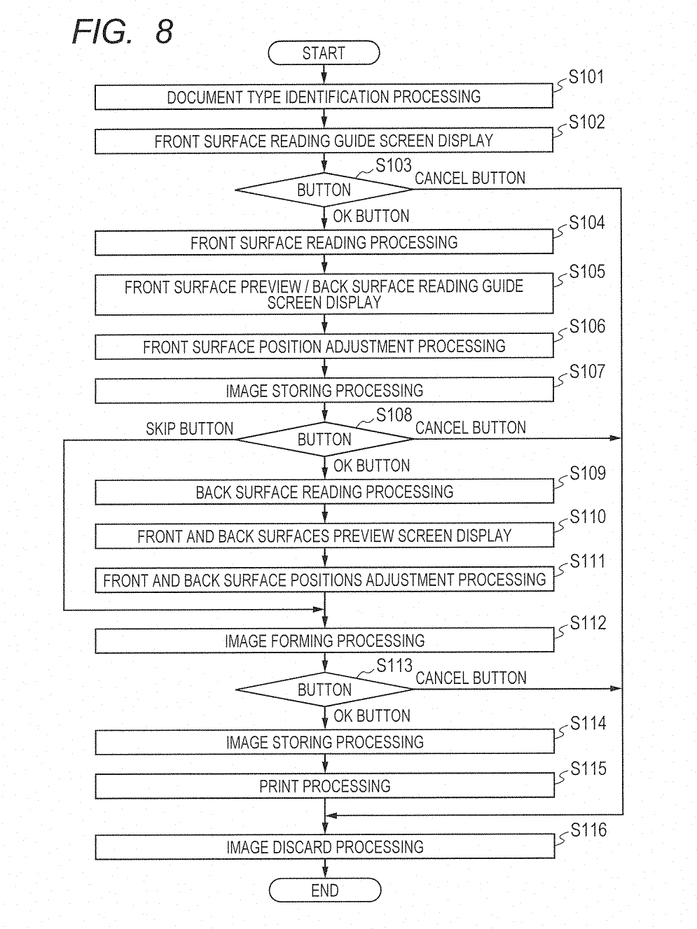

FIG. 8 is a flowchart showing an operation example of the image forming device 200 and the controller 100 according to the first embodiment. As an example, an operation from when a document is placed on the document platen 201 to when printing is performed will be described.

Step S101 is a step where the scanner 124 reads the document placed on the document platen 201 and the document type identification circuit 109 identifies a type of the document by performing image recognition processing on read image data. The type of the document is assumed to be a driver's license, a passport, or the like. When the type of the document is identified, the operation proceeds to step S102. Here, a case in which the document is a driver's license will be described.

Step S102 is a step where information for front surface reading guide is read from the HDD 126 and displayed on the document platen display unit 122 through the document platen display unit interface 107.

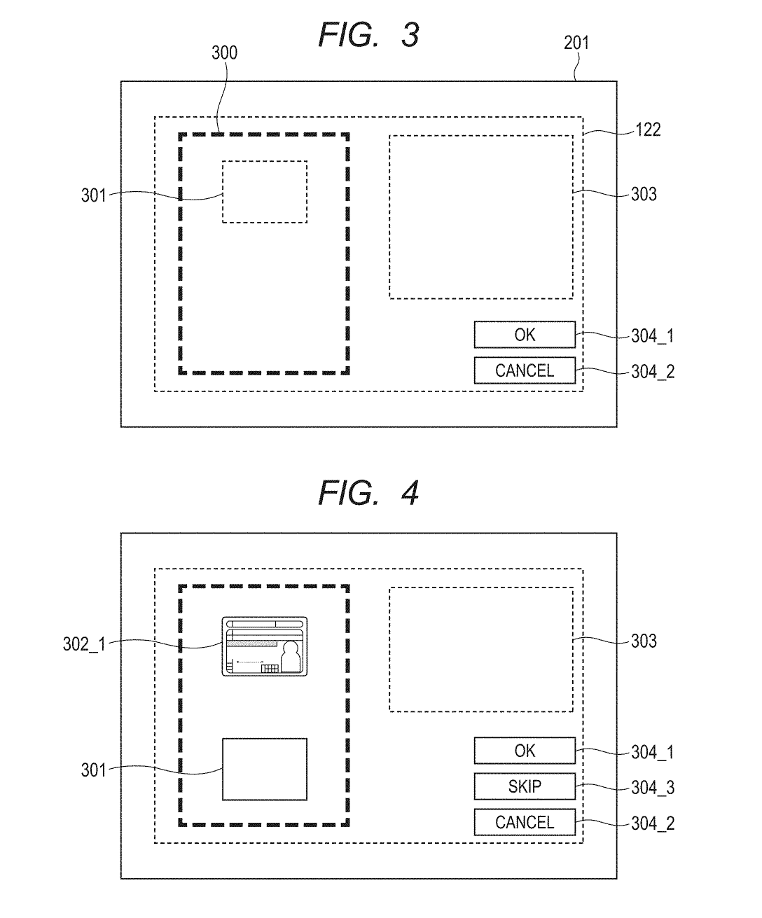

FIG. 3 is a display example of a guide screen for reading a front surface of the document, which is displayed on the document platen display unit 122. The document platen display unit 122 is formed on the entire glass surface of the document platen 201. In this area, liquid crystal cells are arranged in a matrix form. The liquid crystal cells are configured so that the transmittance of each liquid crystal cell can be adjusted. A state in which the transmittance is adjusted to maximum is represented as “transparent”, and a state in which the transmittance is adjusted to minimum is represented as “shielded”, “black”, or the like. When the transmittance is smaller than the maximum and greater than the minimum, the transmittance is represented as “gray scale display” or the like. A reading guide area 301 having the same size as that of the driver's license or a size where a margin is added to the size of the driver's license is displayed on the document platen display unit 122 in order to scan the front surface of the driver's license which is the document. Further, an instruction that prompts a user to perform an expected operation is displayed in an instruction display area 303, and an OK button 304_1 and a cancel button 304_2 that show instruction contents are displayed. Further, a printing paper area 300 may be displayed which indicates position and size of a paper sheet when the paper sheet is printed. When scan is actually performed, the reading guide area 301 is controlled to be transparent, and the other area is shielded.

When the guide screen illustrated in FIG. 3 is displayed, the user sets the driver's license which is the document according to a displayed instruction so that the driver's license is within the reading guide area 301. When preparation of scan is completed, the user presses the OK button 304_1, and when scan is not performed, the user presses the cancel button 304_2.

Let us return to the description of FIG. 8.

Step S103 is a step to determine the button pressed in FIG. 3. When the OK button 304_1 is pressed, the operation proceeds to step S104, and when the cancel button 304_2 is pressed, the operation proceeds to step S116, image discard processing is performed, and then this flowchart is terminated.

Step S104 is a step to read the front surface of the driver's license. In this step, the scanner 124 is operated through the device interface 108, a front surface image according to the reading guide area 301 of FIG. 3 is read, and the image is transmitted to the image processing circuit 110 through the system bus 111. The image processing circuit 110 performs predetermined image processing on the front surface image, and then the front surface image is stored in the RAM 102 through the system bus 111.

Step S105 is a step where information for back surface reading guide is read from the HDD 126 and displayed on the document platen display unit 122 through the document platen display unit interface 107. At the same time, the front surface image is read from the RAM 102, in which the front surface image has been stored in step S104, and displayed as a preview screen.

FIG. 4 is a display example of the preview screen that displays the front surface of the document and a guide screen for reading the back surface of the document, which are displayed on the document platen display unit 122. In the description of the present embodiment, the size of the paper sheet to be printed is assumed to be A4. The printing paper area 300 of A4 size is displayed so as to be indicated by a dashed line. In the center of the upper half of the printing paper area 300, instead of the reading guide area 301 for the front surface of the document, a preview image 302 of the front surface image is displayed, and in the center of the lower half of the printing paper area 300, the reading guide area 301 for the back surface of the document is displayed. In the instruction display area 303, an instruction is displayed that prompts the user to set the driver's license which is the document in the reading guide area 301 so that the back surface faces down. Further, an OK button 304_1, a skip button 304_3, and a cancel button 304_2 are displayed.

When the guide screen illustrated in FIG. 4 is displayed, the user sets the driver's license which is the document inside the reading guide area 301 so that the back surface faces down according to the displayed instruction, and when preparation of scan is completed, the user presses the OK button 304_1. Alternatively, when the user does not perform scan of the back surface, the user presses the skip button 304_3, and when the user cancels the reading of the document including the reading of the front surface that has already been read, the user presses the cancel button 304_2.

Let us return to the description of FIG. 8.

Step S106 is a step where the user adjusts position, orientation, size, and the like of the front surface image of the driver's license displayed on the document platen display unit 122 in step S105. On the liquid crystal panel with a touch panel of the document platen display unit 122, the user adjusts position, size, and the like by touch operations using fingers, touch pen, and the like while imaging an actual size completion. If the touch operation is not performed for a predetermined period of time, the operation proceeds to step S107. It is assumed that a printer maker and a user can freely set the predetermined period of time.

Step S107 is a step to store adjusted data such as the position adjusted in step S106 into a predetermined area in the RAM 102 through the system bus 111.

Step S108 is a step to determine the button pressed in FIG. 4. When the OK button 304_1 is pressed, the operation proceeds to step S109. When the skip button 304_2 is pressed, the operation proceeds to step S112. When the cancel button 304_3 is pressed, the operation proceeds to step S116, image discard processing is performed, and then this flowchart is terminated.

Step S109 is a step to read the back surface of the driver's license. In this step, the scanner 124 is operated through the device interface 108, a back surface image of the driver's license that is set in the reading guide area 301 in the center of the lower half of the printing paper area 300 of A4 size is read as illustrated in FIG. 4, and the image is transmitted to the image processing circuit 110 through the system bus 111. The image processing circuit 110 performs predetermined image processing on the back surface image, and then the back surface image is stored in the RAM 102 through the system bus 111.

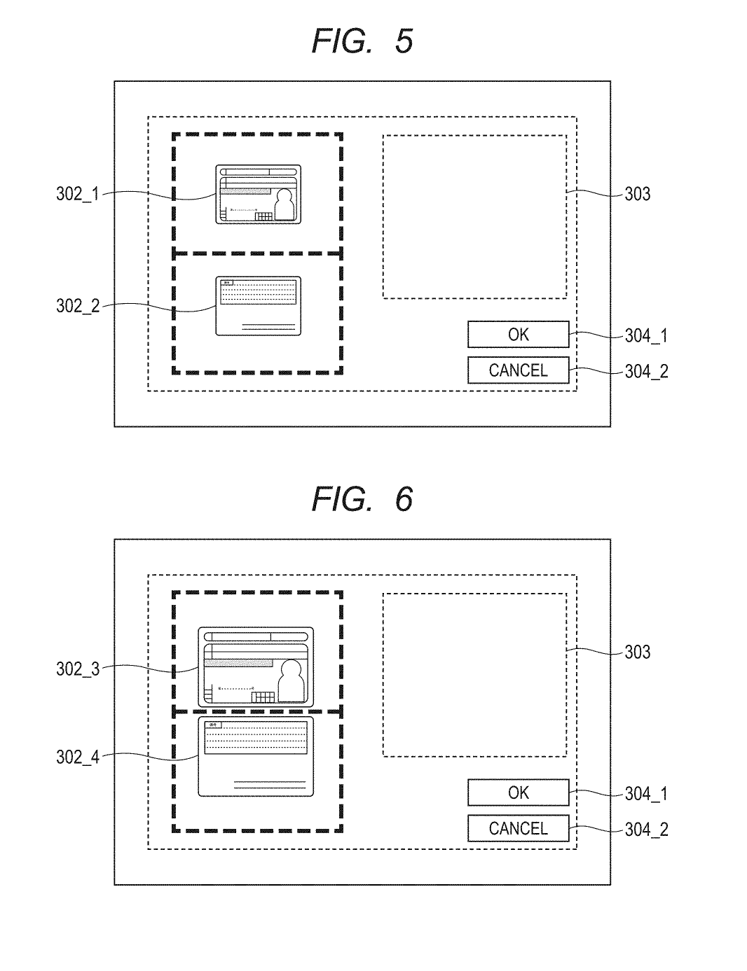

Step S110 is a step where the front surface image stored in step S107 and the back surface image stored in step S109 are read from the RAM 102 through the system bus 111 and the preview screens of the front surface and the back surface are displayed on the document platen display unit 122. FIG. 5 shows a display example displayed on the document platen display unit 122. A preview image 302_1 of the front surface is displayed in the center of the upper half of the printing paper area 300 of A4 size and a preview image 302_2 of the back surface is displayed in the center of the lower half of the printing paper area 300 of A4. In the instruction display area 303, an instruction that prompts the user to adjust position, orientation, size, and the like of the preview images 302_1 and 302_2 is displayed. Further, the OK button 304_1 and the cancel button 304_2 are displayed.

Step S111 is a step where the user adjusts position, orientation, size, and the like of the front and back surface images of the driver's license displayed on the document platen display unit 122 in step S110. On the liquid crystal panel with a touch panel of the document platen display unit 122, the user adjusts position, orientation, size, and the like by touch operations using fingers, touch pen, and the like while imaging an actual size completion. The images after the adjustment are reflected on the preview screen in synchronization with the touch operations. FIG. 6 is a preview screen after enlarging a front surface image 302_1 and a back surface image 302_2, horizontally dividing the A4 size into an upper half and a lower half by a center line, positionally adjusting a front surface image 302_3 in the upper half of the A4 close to the center line, and positionally adjusting a back surface image 302_4 in the lower half of the A4 close to the center line. If the touch operation is not performed for a predetermined period of time, the operation proceeds to step S112.

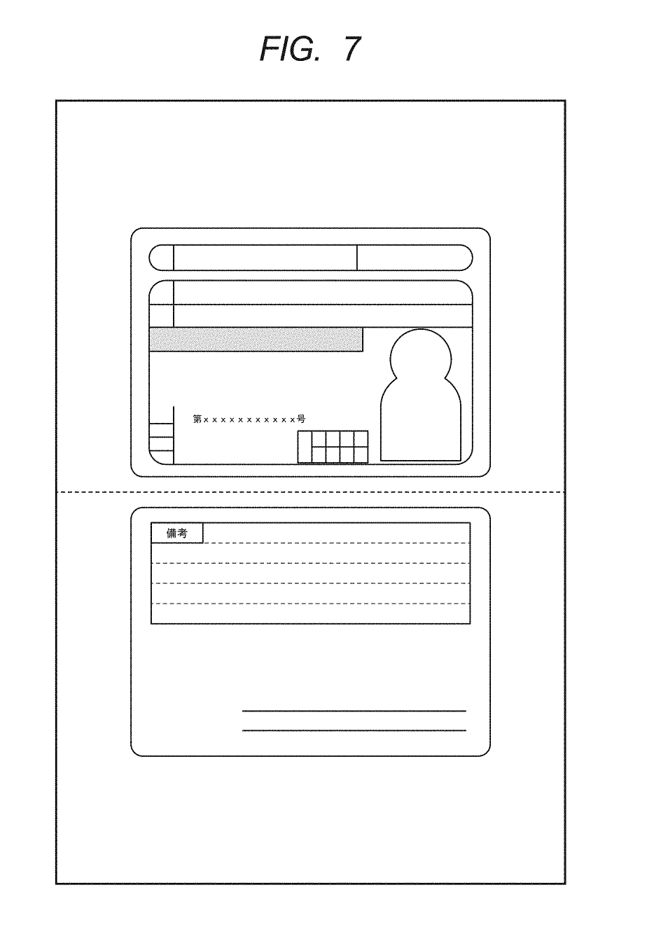

Step S112 is a step to form an image from front surface/back surface image data whose positions and the like are adjusted in step S111. FIG. 7 is a print image after the image of the preview screen of FIG. 6 is formed.

Step S113 is a step to determine a button pressed in FIG. 6. When the OK button 304_1 is pressed, the operation proceeds to step S114. When the cancel button 304_2 is pressed, the operation proceeds to step S116, image discard processing is performed, and then this flowchart is terminated.

Step S114 is a step to store the image formed in step S112 into a predetermined area in the RAM 102 through the system bus 111.

Step S115 is a step to print the image that is stored in the RAM 102 in step S114. The image that is stored in the RAM 102 in step S114 is transmitted to the image processing circuit 110 through the system bus 111. After predetermined image processing is performed on the image, the printer 125 is operated through the device interface 108 and the image is printed.

Step S116 is a step to delete images formed in and before step S114 from RAM 102 and the like. After step S116 is completed, this flowchart is terminated.

As described above, by providing the document type identification circuit 109, it is not necessary to manually set the type of document such as “driver's license mode” to the image forming device (copying machine) 200 before starting a copy operation. By providing the document platen display unit 122, which can perform transmission type liquid crystal display by adjusting the transmittance of each area for each cell, to the document platen 201, it is possible to display a print image at actual size, so that it is possible to easily image a print result. Therefore, it is possible to reduce printing mistakes. By adding a touch panel to the document platen display unit 122, it is possible to adjust position, size, orientation, and the like of the driver's license by displaying the preview screen after reading the image of the driver's license. As a result, it is not necessary to perform setting before starting a copy operation.

### Second Embodiment

The second embodiment is an embodiment in which a function to lock the copy operation is added to the first embodiment described above to prevent illegal copy or spoofed copy of an identification card such as a driver's license.

The image forming device 200 is further provided with a camera 123 that can capture an image of a user who sets a document on the document platen 201. The controller 100 is configured to be able to perform personal authentication processing by using image data of a user whose image is captured by the camera 123. For example, the controller 100 performs personal authentication processing by extracting image data of a person from initial image data obtained by reading a document including a face photo such as, for example, a front surface of a driver's license and comparing the image data of the person with the image data of the user whose image is captured by the camera 123. At the time point when the controller 100 has read the initial image data, the controller 100 prohibits printing of image data of the initial image data or image data based on the initial image data and cancels the prohibition when the personal authentication processing described above is successfully performed.

Thereby, it is possible to prohibit a person other than the person of the image data read by a scanner from printing the image data, so that it is possible to prevent illegal copying.

It may be configured so that, at the time point when the initial image data has been read, in addition to printing of the image data, outputting of the image data to the outside through LAN is also prohibited, and the prohibition is cancelled when the personal authentication processing is successfully performed.

FIG. 1 is also a block diagram showing a configuration example of the image forming device 200 according to the second embodiment. FIG. 2 is a perspective view of an upper portion of the image forming device 200. In the same manner as in the first embodiment, the copying machine 200 includes a main body 202, an operation unit 121, a document platen 201, a document platen cover 203, and a paper discharge tray 204. The copying machine 200 further includes a camera 123 that can capture an image of a user in, for example, the operation unit 121. As shown in FIG. 1, the camera 123 is coupled to the controller 100 and controlled by the device interface 108. Image data captured by the camera 123 can be transmitted to the RAM 102 and the like through the device interface 108 and the system bus 111 and can be used by the CPU 101 and the like. The other components and operations are the same as those of the first embodiment, so that the description thereof will be omitted.

Operations characteristic to the second embodiment will be described.

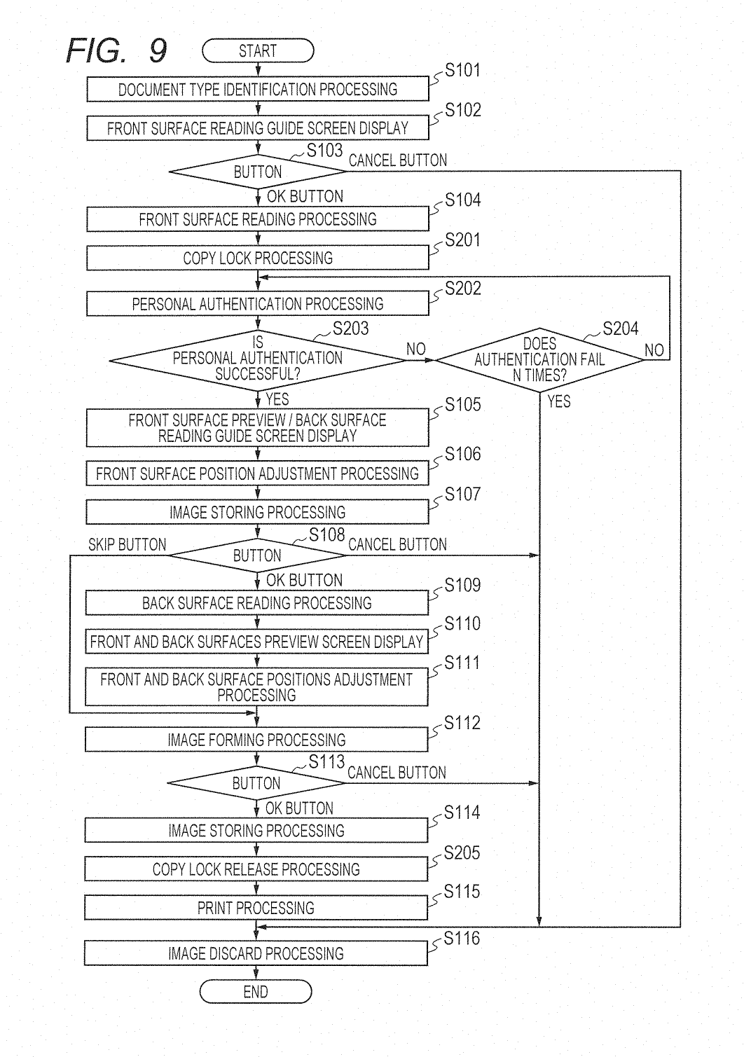

FIG. 9 is a flowchart showing an operation example of the image forming device 200 according to the second embodiment.

Steps S101 to S104 are the same as those of the flowchart of the first embodiment shown in FIG. 8, so that the description thereof will be omitted. After the front surface reading processing is completed in step S104, the operation automatically proceeds to step S201.

Step S201 is a step to lock (prohibit) the printing operation, so that the printing operation is not accepted. For example, the function of the printer 125 may be disabled.

Step S202 is a step to authenticate that the user who operates the image forming device 200 is a person who possesses the driver's license. In the present embodiment, a face photo of the user is captured by the camera 123, and image recognition is performed which determines whether the face photo of the camera 123 corresponds to the image of the driver's license front surface that is read in step S104. The function of the image recognition may be realized by adding an image recognition block as hardware (not shown in FIG. 1) or may be realized by software processing using the CPU 101.

As a method other than the image recognition by the camera, the document platen display unit 122 display a screen for inputting a national identification number, and a user may input a personal number such as the national identification number. A driver's license number is extracted from an image read from the driver's license front surface by image recognition, and the driver's license number and the national identification number are managed to confirm that the driver's license number corresponds to the national identification number. A security server or the like (not shown in the drawings) that is coupled to the LAN 120 is used. Further, for the personal authentication, it is possible to use the method of image recognition by the camera together with the method of inputting a personal number such as a national identification number.

Step S203 is a step to determine whether the user can be authenticated as the holder of the driver's license. When the personal authentication is successfully performed, the operation proceeds to step S105. When the personal authentication fails, the operation proceeds to step S204.

Step S204 is a step to determine the number of times when the personal authentication fails. When the personal authentication fails N times which is a predetermined number of times, it is determined that the user makes illegal copy and the operation proceeds to step S116. When the number of times of the authentication failure is smaller than or equal to N−1, it is determined that the image recognition by the camera 123 fails or an input error of national identification number occurs, the operation proceeds to step S202, and the personal authentication processing (S202) is performed again.

Steps S105 to S114 are the same as those of the first embodiment, so that the description thereof will be omitted. Since the personal authentication is successfully performed in step S203, step S203 is a step to release the lock of the printing operation. For example, the function of the printer 125 is enabled. After this step is completed, the operation proceeds to step S115 and printing is performed.

As described above, by providing copy lock processing and copy lock release function, it is possible to prevent illegal copy and spoofed copy performed by other than the person of the driver's license. By using image recognition function by camera photographing and input of national identification number as a personal authentication function, it is possible to perform highly accurate personal authentication and prevent illegal copy and the like.

While the invention made by the inventors has been specifically described based on the embodiments, it is needless to say that the present invention is not limited to the embodiments and may be variously modified without departing from the scope of the invention.

What is claimed is:

1. A image forming device comprising:
a document platen;
a scanning mechanism; and
a controller,
wherein the document platen has a document platen display unit that is controlled by the controller,
wherein the scanning mechanism can read an image of a document placed on the document platen and transmit a read initial image data to the controller, and
wherein the controller can cause the document platen display unit to display image data based on the initial image data.

2. The image forming device according to claim 1, further comprising:
a printing mechanism,
wherein the controller can edit the initial image data and cause the document platen display unit to display either one or both of the initial image data before being edited and image data after being edited, and
wherein the controller can form print data including either one or both of the initial image data before being edited and the image data after being edited and cause the printing mechanism to print the print data.

3. The image forming device according to claim 2,
wherein the controller can identify a type of the document based on the initial image data and cause the document platen display unit to display a guide screen that shows a reading guide area where the document should be placed according to a result of the identification.

4. The image forming device according to claim 3,
wherein the controller can display the initial image data in the reading guide area of the document platen display unit.

5. The image forming device according to claim 3,
wherein the controller can make the reading guide area of the document platen display unit transparent and block transmission of light in an area other than the reading guide area.

6. The image forming device according to claim 1, further comprising:
a printing mechanism; and
a camera,
wherein the camera can capture an image of a user who places the document on the document platen,
wherein the controller can perform personal authentication process that extracts image data of a person from the initial image data and compares the image data of the person with image data of the user whose image is captured by the camera, and
wherein the controller can prohibit printing of the initial image data or image data based on the initial image data by the printing mechanism and cancel the prohibition based on an execution result of the personal authentication processing.

7. The image forming device according to claim 6,
wherein when the controller cancels the prohibition of printing based on the execution result of the personal authentication processing,
the controller edits the initial image data and allows the document platen display unit to display either one or both of the initial image data before being edited and image data after being edited, and
the controller forms print data including either one or both of the initial image data and the image data after being edited and allows the printing mechanism to print the print data.

8. The image forming device according to claim 7,
wherein when the controller cancels the prohibition of printing based on the execution result of the personal authentication processing, the controller identifies a type of the document based on the initial image data and allows the document platen display unit to display a guide screen that shows a reading guide area where the document should be placed according to a result of the identification.

9. A semiconductor device to be mounted in an image forming device including a document platen having a document platen display unit and a scanning mechanism that reads an image of a document placed on the document platen, the semiconductor device comprising:
a device interface for controlling the scanning mechanism and receiving read initial image data from the scanning mechanism, and
a document platen display unit interface for causing the document platen display unit to display image data based on the initial image data.

10. The semiconductor device according to claim 9,
wherein the image forming device further includes a printing mechanism,
wherein the semiconductor device further includes an image processing circuit,
wherein the image processing circuit can edit the initial image data to form image data after being edited and form either one or both of preview image data and print data,
wherein each of the preview image data and the print data includes either one or both of the initial image data and the image data after being edited,
wherein the document platen display unit interface can perform control to output the preview image data to the document platen display unit and cause the document platen display unit to display the preview image data, and
wherein the device interface can perform control to output the print data to the printing mechanism and cause the printing mechanism to print the print data.

11. The semiconductor device according to claim 10, further comprising:
a document type identification circuit,
wherein the document type identification circuit can identify a type of the document based on the initial image data, and
wherein the document platen display unit interface can perform control to cause the document platen display unit to display a guide screen that shows a reading guide area where the document should be placed according to a result of the identification.

12. The semiconductor device according to claim 11,
wherein the document platen display unit interface can perform control to display the initial image data in the reading guide area of the document platen display unit.

13. The semiconductor device according to claim 11,
wherein the document platen display unit interface can perform control to make the reading guide area of the document platen display unit transparent and block transmission of light in an area other than the reading guide area.

14. The semiconductor device according to claim 9,
wherein the image forming device further includes a printing mechanism and a camera that can capture an image of a user who places the document on the document platen,
wherein the semiconductor device further includes an image processing circuit,
wherein the image processing circuit can perform personal authentication processing that extracts image data of a person from the initial image data and compares the image data of the person with image data of the user whose image is captured by the camera,
wherein the device interface can perform control to cause the printing mechanism to print print data, and
wherein the image processing circuit can prohibit printing of the initial image data or image data based on the initial image data by the printing mechanism and cancel the prohibition based on an execution result of the personal authentication processing.

15. The semiconductor device according to claim 14,
wherein when the image processing circuit cancels the prohibition of printing based on the execution result of the personal authentication processing,
the image processing circuit edits the initial image data and allows the document platen display unit to display either one or both of the initial image data before being edited and image data after being edited, and
the image processing circuit forms print data including either one or both of the initial image data and the image data after being edited and al lows the device interface to cause the printing mechanism to print the print data.

16. The semiconductor device according to claim 15,
wherein when the image processing circuit cancels the prohibition of printing based on the execution result of the personal authentication processing, the image processing circuit identifies a type of the document based on the initial image data and allows the document platen display unit interface to cause the document platen display unit to display a guide screen that shows a reading guide area where the document should be placed according to a result of the identification.
